(19) United States
(12) Patent Application Publication
(10) Pub. No.: US 2026/0093522 A1
(43) Pub. Date: Apr. 2, 2026

(54) RUNTIME MONITORING OF MACHINE LEARNING-BASED SCHEDULING ALGORITHMS TOWARD ROBUST DOMAIN-SPECIFIC SYSTEMS-ON-CHIP

(71) Applicant: Wisconsin Alumni Research Foundation, Madison, WI (US)

(72) Inventors: Umit Ogras, Middleton, WI (US); Ahmet Alper Goksoy, Madison, WI (US); Alish Kanani, Madison, WI (US)

(21) Appl. No.: 18/899,711

(22) Filed: Sep. 27, 2024

(51) Int. Cl. G06F 9/48; G06F 15/78

(52) U.S. Cl. CPC G06F 9/4881; G06F 15/7807

(57) ABSTRACT

Systems and methods of runtime monitoring a machine learning-based (ML) scheduler for a system-on-chip (SoC) including determining a scheduling action by the ML-based scheduler for an SoC task, the scheduling action based on a policy trained from training data, permitting the scheduling action to be processed by at least one processing element of the SoC, evaluating a quality of the scheduling action, and determining the scheduling action does not generalize to the policy based on the quality of the scheduling action. The policy can be incrementally retrained to generate an updated policy.

### STATEMENT REGARDING FEDERALLY SPONSORED RESEARCH OR DEVELOPMENT

This invention was made with government support under FA8650-18-2-7860 awarded by the Defense Advanced Research Projects Agency (DARPA). The government has certain rights in the invention.

### TECHNICAL FIELD

Embodiments relate generally to resource monitoring for systems-on-chip (SoCs). More particularly, embodiments relate to runtime monitoring for schedulers implementing machine learning algorithms.

### BACKGROUND

Machine learning (ML) algorithms are being rapidly adopted to perform dynamic resource management tasks in heterogeneous system-on-chips. For example, ML-based task schedulers can typically make quick, high-quality decisions at runtime. However, like any ML model, offline-trained policies for scheduling decisions depend critically on the representativeness of the training data. Hence, ML model performance may diminish or even catastrophically fail under unknown workloads, especially new applications. Therefore, there is a need for improved monitoring of ML-based automated schedulers.

### SUMMARY

Embodiments substantially meet the aforementioned needs of the industry. Systems and methods for continuously monitoring SoCs detect unforeseen scenarios using a gradient-based generalization metric called coherence. Embodiments can accurately determine whether a current ML policy generalizes to new inputs. If the current policy cannot be generalized to new inputs, the ML scheduler is incrementally trained to ensure the robustness of task-scheduling decisions.

In one aspect, if a ML-trained system, such as a scheduler, is exposed to new data that does not match what the ML model has been trained on, embodiments can resolve the issue in real time, by indicating that there is a problem, stopping the process, updating the system, and re-implementing the scheduler.

In a feature and advantage of embodiments, runtime monitoring can be performed in real-time as a background task while a ML-based scheduler assigns incoming tasks to processing elements in the SoC. Real-time continuous monitoring continuously monitors the system, identifying unforeseen tasks and incrementally training the model, thereby improving future scheduling.

In a feature and advantage of embodiments, gradients are leveraged to quantify generalization to new data without making assumptions about the input data. Accordingly, embodiments are more flexible to adapt to evolving data distributions than traditional systems, which are limited by their inherent assumptions about the input data.

In a feature and advantage of embodiments, scheduler decisions can be detected when unreliable with high accuracy; in some examples, with 88.75% to 98.39% accuracy. In a feature and advantage of embodiments, 1.1× to 14× lower execution time can be achieved by incremental retraining in ML-based schedulers.

In an embodiment, a method of runtime monitoring a machine learning-based scheduler for a system-on-chip comprises determining a scheduling action by the ML-based scheduler for an SoC task, the scheduling action based on a policy trained from training data; permitting the scheduling action to be processed by at least one processing element of the SoC; evaluating a quality of the scheduling action; and determining the scheduling action does not generalize to the policy based on the quality of the scheduling action.

In an embodiment, a system for runtime monitoring for a system-on-chip comprises at least one processing element (PE) configured to execute SoC application tasks; a memory operably coupled to the at least one PE; a runtime task scheduler implementing a machine learning-based policy for SoC application task scheduling; and a runtime monitor configured to: determine a scheduling action by the ML-based scheduler for an SoC application task, permit the scheduling action to be processed by the at least one PE, evaluate a quality of the scheduling action, and determine the scheduling action does not generalize to the policy based on the quality of the scheduling action.

In an embodiment, a computer readable media comprising non-transitory computer executable instructions which, when executed by at least one processing element on a system-on-chip (SoC), perform at least: determining a scheduling action by the ML-based scheduler for an SoC task, the scheduling action based on a policy trained from training data; permitting the scheduling action to be processed by at least one processing element of the SoC; evaluating a quality of the scheduling action; and determining the scheduling action does not generalize to the policy based on the quality of the scheduling action.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a graph illustrating variation in execution time for a traditionally deployed machine-learning scheduling algorithm and an incrementally trained machine-learning scheduling algorithm, according to an embodiment.

FIG. 2 is a graph illustrating relationships between coherence and accuracy throughout training of a runtime monitoring policy, according to an embodiment.

FIG. 3 is a block diagram of an SoC scheduler monitoring system, according to an embodiment.

FIG. 4 is a flowchart of a method for continuous monitoring of an SoC, according to an embodiment.

FIG. 5 is a block diagram of an SoC scheduler monitoring system, according to an embodiment.

FIG. 6 is a block diagram of imitation learning-based scheduler monitoring operation, according to an embodiment.

FIG. 7 is pseudocode of a detection algorithm for an imitation learning-based scheduler, according to an embodiment.

FIG. 8 is a block diagram of reinforcement learning-based scheduler monitoring operation, according to an embodiment.

FIG. 9 is pseudocode of a detection algorithm for a reinforcement learning-based scheduler, according to an embodiment.

FIG. 10A is a graph of coherence against time for a simulation of an imitation learning-based scheduler in a single application use case, according to an embodiment.

FIG. 10B is a graph of average execution time against time for a simulation of an imitation learning-based scheduler in a single application use case, according to an embodiment.

FIG. 11A is a graph of coherence against time for a simulation of an imitation learning-based scheduler in a multiple application use case, according to an embodiment.

FIG. 11B is a graph of average execution time against time for a simulation of an imitation learning-based scheduler in a multiple application use case, according to an embodiment.

FIG. 12 is a table of accuracy and execution time improvements for runtime monitoring of imitation learning-based and reinforcement learning-based scheduler simulations, according to an embodiment.

FIG. 13A is a graph of coherence against time for a simulation of a reinforcement learning-based scheduler in a single application use case, according to an embodiment.

FIG. 13B is a graph of average execution time against time for a simulation of a reinforcement learning-based scheduler in a single application use case, according to an embodiment.

FIG. 14A is a graph of coherence against time for a simulation of a reinforcement learning-based scheduler in a multiple application use case, according to an embodiment.

FIG. 14B is a graph of average execution time against time for a simulation of a reinforcement learning-based scheduler in a multiple application use case, according to an embodiment.

FIG. 15 is a table of example monitoring overhead for an imitation learning-based scheduler, according to an embodiment.

FIG. 16 is a table of example monitoring overhead for a reinforcement learning-based scheduler, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Heterogeneous computing architectures integrate diverse computing elements, each tailored to optimize specific objectives, resulting in enhanced performance across various fronts of optimization. Among these architectures, domain-specific SoCs are designed to excel in particular domains such as augmented/virtual reality, autonomous driving, and telecommunication. SoCs maximize energy efficiency by integrating domain-specific hardware accelerators while supporting general-purpose computing by including general-purpose cores, thereby effectively blending adaptability and efficiency. In the context of scheduling, the nondeterministic polynomial-time complete (NP-complete) nature of the task scheduling problem poses significant challenges to traditional algorithms as the number of processing elements (PEs) and tasks increase due to the concurrent execution of multiple applications.

ML-based policies can deliver fast and high-quality decisions tailored to a particular domain by leveraging system, application, and task information as features. ML-based policies are trained using diverse workloads representing a target domain. ML-based schedulers operate reliably within the confines of the datasets and applications used during training, and in contrast to traditional systems which may fail or suffer performance deterioration when faced with new workload scenarios, especially those involving new applications, embodiments monitor scheduling decisions to detect any non-robust decisions and adapt the system accordingly.

Systems and methods monitor the actions of an ML-based scheduler, detect input changes that deviate from the training data, and incrementally train the ML policy to adapt to the new application.

In an embodiment, a system implements at least one of two runtime task schedulers, a first runtime task scheduler trained using imitation learning (IL) and a second runtime task scheduler trained using reinforcement learning (RL). Runtime monitoring is performed as a background task while an ML scheduler assigns incoming tasks to the PEs in the SoC. The runtime monitor first reads the features used by the ML scheduler, such as expected task execution times and PE states. The gradient of the trained ML policy is computed and then, a coherence value using the gradient is computed. When the gradient of the trained policy and information added by the new data samples are aligned, a coherence value is low, indicating that the current model generalizes well to the latest data samples. In contrast, when the latest data samples are not aligned with training, the coherence increases, indicating the need for retraining. When this happens, the ML policy is incrementally updated, adapting the policy to new applications while retaining past information.

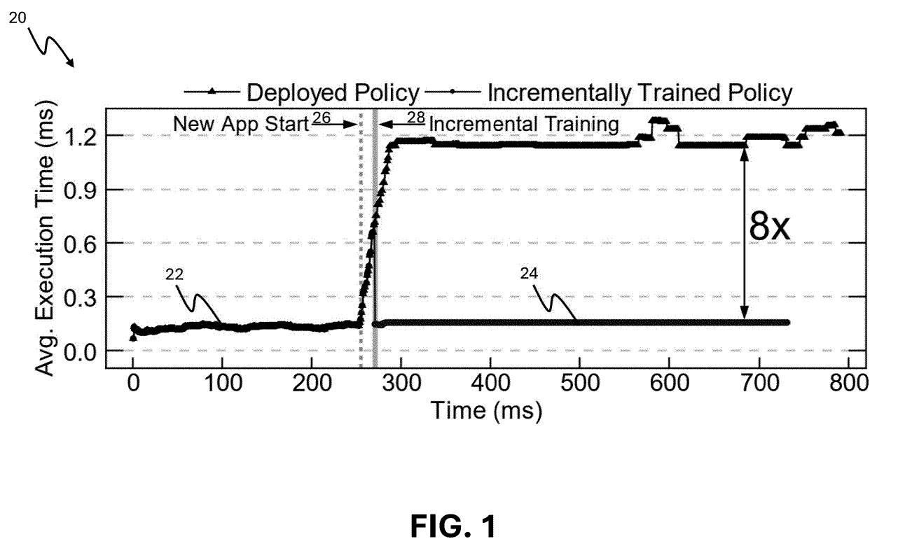

Referring to FIG. 1, a graph 20 of variation in execution time for a traditionally deployed machine-learning scheduling algorithm 22 and an incrementally trained machine-learning scheduling algorithm 24 is depicted, according to an embodiment. In an example, traditionally deployed algorithm 22 and incrementally trained algorithm 24 are IL-based scheduling algorithms. FIG. 1 illustrates the technical solution of reducing the variation in execution time as an ML policy schedules streaming tasks to the PEs in an SoC.

Initially, an SoC runs a mixture of applications that were used while training the ML scheduler. New app start 26 (new application starting) illustrates the arrival of an unknown application. The average execution time of deployed algorithm 26 begins to increase substantially after the arrival of the unknown application and converges to the execution time of the new application. In one aspect, execution time begins to increase because the decisions of the scheduler implementing deployed algorithm 22 are incorrect. In an example, schedulers implementing traditional policies (e.g. deployed algorithm 22) can fail to recognize that one of the tasks in the new application could utilize a hardware accelerator PE.

In contrast, as described herein, embodiments can detect the arrival of a new application class and incrementally train the scheduler to achieve significantly higher performance. Accordingly, embodiments are configured to recognize input changes (e.g., the arrival of a new application) to which the scheduler does not generalize and implement on-the-fly incremental training to adapt the scheduler to changes in data distribution over time while retaining knowledge from past data. In this context, “on-the-fly” includes training while the scheduler is implementing the policy. In one aspect, on-the-fly incremental training allows for real-time implementation. Incremental training 28 illustrates the time in which the policy is updated with an incrementally trained version. Execution time is 8× lower after incremental training (comparing incrementally trained algorithm 24 to deployed algorithm 22).

With respect to training, embodiments can implement deep learning models trained with gradient descent. Traditional systems that implement deep learning models have the capacity to memorize training data and fail to generalize, which can lead to poor accuracy on new data, indicating memorization. In contrast, embodiments described and considered herein implement coherent gradients, or put otherwise, gradients calculated from similar training samples that point in similar directions for generalization (rather than memorization). Interaction and reinforcement between gradients from different training examples lead the model to learn features that generalize well to unseen data.

Suppose z is a sample from a batch (M) with M=| [symbol] | data samples. Further, let l_{z}(w) denote the loss function for this sample, where w represents the trainable parameters of this model. The gradient for this sample can be defined by Equation 1.

$${g}_{z} = [ ∇ {l}_{z} ] ( w ) \qquad ( Equation 1 )$$

The coherence over these M samples using per-sample gradients refers to the similarity between per-sample gradients and can be defined according to Equation 2.

$${α}_{M} = M \cdot \frac{{𝔼}_{z ∼ ℳ} [ {g}_{z} ] \cdot {𝔼}_{z ∼ ℳ} [ {g}_{z} ]}{{𝔼}_{z ∼ ℳ} [ {g}_{z} \cdot {g}_{z} ]} \qquad ( Equation 2 )$$

When gradients (gz) are perfectly aligned, the numerator and denominator will be equal, leading to maximum coherence (M). When all samples are fit, coherence will be zero, meaning the individual gradients will become zero. During the initial training epochs, training data often shares many common features. This results in aligned gradients and, consequently, a higher coherence value. As training progresses and trainable parameters converge, new features become more specific, and the model tries to learn them individually. Consequently, the coherence value tends to decrease.

Notably, determinations based on a batch of decisions allows for meaningful evaluation of a ML policy. For example, it is difficult to draw conclusions based on evaluations of single decisions in isolation. Likewise, determinations based on all of a policy's decisions are difficult and costly to analyze. Accordingly, embodiments employing selective batches of decisions provide effective and efficient analysis of the generalization of the ML policy.

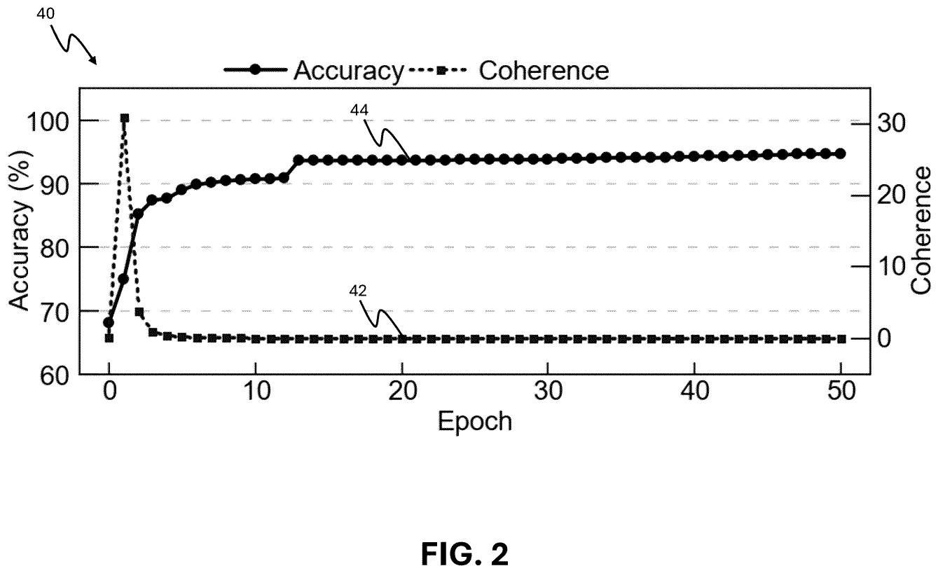

Referring to FIG. 2, a graph 40 illustrating relationships between coherence 42 and accuracy 44 throughout training of a runtime monitoring policy is depicted, according to an embodiment. As illustrated, examples exhibit stronger mutual support in early epochs (e.g. epochs 0-3), resulting in higher coherence (right y-axis). As training progresses, the expected gradient of samples approaches zero, indicating that the samples no longer provide significant assistance to one another. Consequently, coherence tends to diminish towards zero by the end of the training period.

Accordingly, coherence can be utilized for runtime monitoring. Gradients reinforce each other when learning takes place during the early training phases, leading to high coherence, as shown in the first few epochs of FIG. 2. After the ML model has learned what is common to all the samples and the samples have been fit (in a well-generalizing manner), the coherence drops and stabilizes to a low value. When the workload falls within the generalized set at runtime (not necessarily identical to the training data), its behavior resembles the end of the training phase illustrated in FIG. 2. Consequently, scheduling is characterized by a low coherence value (like the latest data sample during training). However, if the new data samples deviate from the training data, their gradients would align, leading to a rise in the coherence value. Therefore, increasing coherence indicates that the model processes features from an application that the model has not generalized yet. The coherence will remain high unless the ML policy, e.g., the scheduling algorithm, is incrementally trained. A runtime monitor thus implements determinations that low coherence for generalized workload indicates good performance, while a sustained high coherence suggests encountering new data that requires retraining.

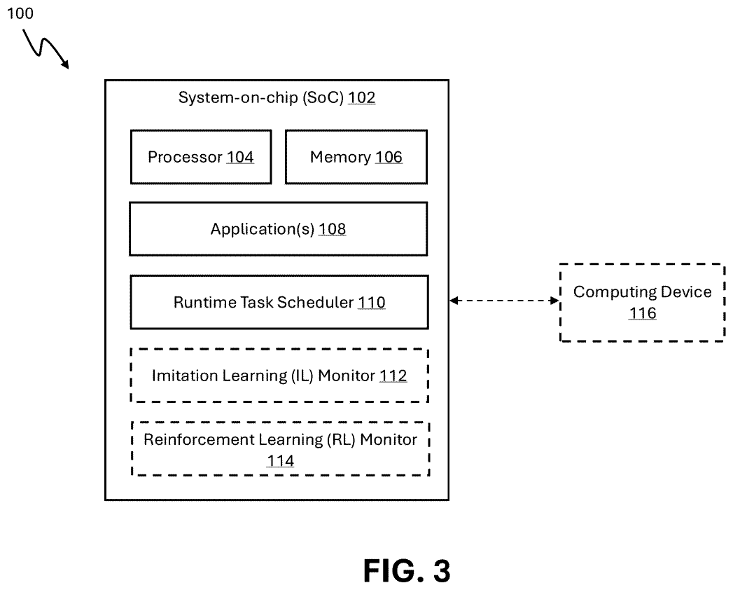

Referring to FIG. 3, a block diagram of an SoC scheduler monitoring system 100 is depicted, according to an embodiment. System 100 generally comprises a system-on-chip (SoC) 102.

SoC 102 can comprise an integrated circuit (IC) that combines function elements onto a single chip instead of using separate components mounted to a motherboard, as is done in traditional electronics design. SoC 102 can be characterized by high performance (e.g. minimum execution time and highest throughput), minimum power consumption, and high energy efficiency. In one aspect, SoC 102 can be a domain-specific SoCs configured to deliver high performance when running applications from a target domain. A defining characteristic of these applications is processing streaming inputs for prolonged periods, such as a domain-specific SoC for telecommunication. When a user starts a WiFi application, the application processes received frames or transmits new ones for minutes, if not hours. Throughout this duration, the SoC continuously schedules the tasks comprising WiFi transmitter and receiver chains.

As illustrated in FIG. 3, SoC 102 generally comprises a processor 104, memory 106, one or more applications 108, a runtime task scheduler 110, and at least one of an imitation learning (IL) monitor 112 and a reinforcement learning (RL) monitor 114, in an embodiment.

Embodiments described herein include various engines, each of which is constructed, programmed, configured, or otherwise adapted, to autonomously carry out a function or set of functions, such as IL monitor 112 and RL monitor 114. The term engine (or “monitor”) as used herein is defined as a real-world device, component, or arrangement of components implemented using hardware, such as by an application-specific instruction set processor (ASIP), an application specific integrated circuit (ASIC), or field-programmable gate array (FPGA), for example, or as a combination of hardware and software, such as by a microprocessor system and a set of program instructions that adapt the engine to implement the particular functionality, which (while being executed) transform the microprocessor system into a special-purpose device, such as an SoC implementing scheduling monitoring. An engine can also be implemented as a combination of the two, with certain functions facilitated by hardware alone, and other functions facilitated by a combination of hardware and software. In certain implementations, at least a portion, and in some cases, all, of an engine can be executed on the processor(s) that are made up of hardware (e.g., one or more processors, data storage devices such as memory, input/output facilities such as network interface devices, video devices, etc.) In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Processor 104 is a processing element of SoC 102. In an embodiment, processor 104 comprises a processor core, such as a microcontroller, microprocessor (μP), digital signal processor (DSP), an application specific integrated circuit (ASIC), or field-programmable gate array (FPGA) or application-specific instruction set processor (ASIP) core.

Memory 106 is a processing element of SoC 102. In an embodiment, memory 106 comprises semiconductor memory blocks and can include read-only memory (ROM), random-access memory (RAM), Electrically Erasable Programmable ROM (EEPROM) and flash memory. Memory 106 is operably coupled to processor 104.

Application 108 comprises SoC-specific instructions for the particular functional implementation of SoC 102. For example, application 108 can be a WiFi application configured for sending and receiving WiFi communications.

Runtime task scheduler 110 comprises an ML-based scheduler for tasks of SoC 102. In an embodiment, ML-based task schedulers leverage various features, including performance counters, task, and application-related data, to make informed decisions related to task scheduling. As illustrated in FIG. 3, runtime task scheduler 110 can schedule tasks associated with application 108.

In one aspect, runtime task scheduler 110 can implement an IL-based scheduler. Imitation learning is an ML method where an agent learns a policy (π) that mimics the behavior of an expert (π*) using the expert's actions. Imitation learning aims to minimize the error between the actions taken by the IL agent (aₜ) and the expert

$$( {a}_{t}^{*} ) .$$

The expert actions

$$( {a}_{t}^{*} )$$

are collected offline and paired with corresponding states

$$( {s}_{t} , {a}_{t}^{*} )$$

for the agent to learn a policy (π_{θ}).

In the context of task scheduling, imitation learning-based models leverage offline training capabilities. For example, training data is collected through executing various workloads under different system states to cover low to high congestion. During this process, an expert scheduler makes decisions for these workloads, with the data representing the system state (sₜ) collected alongside the expert's policy decisions (π*(sₜ)). System states and their corresponding action pairs are then utilized as features and target labels for supervised learning methods within the imitation learning model. Subsequently, the learned imitation learning policy (π_{θ}) is deployed for runtime decision-making, replacing the expert policy (π*).

In one aspect, runtime task scheduler 110 can implement an RL-based scheduler. Unlike IL schedulers, RL schedulers do not require an expert scheduler to guide the policy toward optimal behavior. During training, the agent interacts with the environment by taking action (aₜ) based on the current state (sₜ), such as expected task execution and earliest PE availability times. For each action, the environment gives the agent a reward (rₜ) that reflects how well the action aligns with the performance objectives, such as minimizing the execution time. RL training algorithms can use actor-critic architectures, where the actor selects the actions (aₜ), and the critic evaluates their expected outcomes. Both the actor and critic are continuously updated based on the feedback from the environment in terms of reward, allowing the agent to refine its policy (π_{θ}) over time. The agent aims to optimize policy (π_{θ}) that takes actions to maximize the total reward over time. The state value function can be used to find expected rewards starting from an initial state following the policy. This value function (V_{φ}(sₜ)) can be approximated with a critic network with parameter (φ) that returns an expected value according to the state of the environment.

IL monitor 112 is configured to monitor tasks and scheduling decisions related to runtime task scheduler 110 as an IL-based scheduler. IL monitor 112 is further configured to incrementally re-train runtime task scheduler 110 as an IL-based scheduler. RL monitor 114 is configured to monitor tasks and scheduling decisions related to runtime task scheduler 110 as an RL-based scheduler. RL monitor 114 is further configured to incrementally re-train runtime task scheduler 110 as an RL-based scheduler.

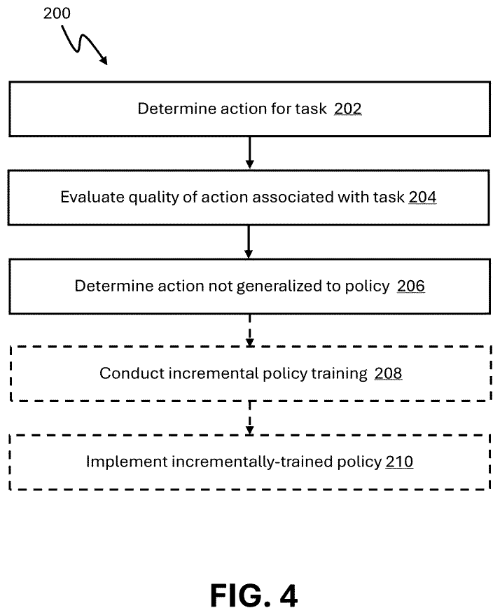

Though both IL monitor 112 and RL monitor 114 are depicted in dashed line, system 100 generally implements either IL monitor 112 or RL monitor 114 at a given time, and not both at the same time (because ML-based schedulers typically implement one or the other type of ML). IL monitor 112 and RL monitor 114 operations are described further with respect to FIGS. 4-9.

Optionally, monitoring system 100 can further comprise a computing device 116. For example, computing device 116 can be a desktop computer, laptop computer, tablet, or other computing device, such as a network component. In an embodiment, computing device 116 can be operably coupled to SoC 102 such as over a wired or wireless network.

Computing device 116 can be configured for interaction with one or more components of SoC 102. In one example, computing device 116 can implement the aforementioned offline training capabilities for imitation learning-based models. In another example, computing device 116 can comprise a device in particular communication with a domain-specific application 108 (e.g. a telecommunication device).

Referring to FIG. 4, a flowchart of a method 200 for continuous monitoring of an SoC is depicted, according to an embodiment. Method 200 can be implemented by, for example, system 100 and can detect variations in workload that can lead to incorrect decisions, as well as update the SoC scheduler in real-time. In embodiments, method 200 can be implemented as a background process to avoid and performance impact to the SoC.

At 202, an action related to a task is determined. For example, the scheduler receives a task and takes an action at time T₀. The SoC runs as usual by committing this action without the runtime monitor (e.g. IL monitor 112 or RL monitor 114) interrupting the operation. At the same time, the runtime monitor operating in the background detects the task and the action taken by the scheduler.

At 204, after the action is completed, the quality of the action associated with the task is evaluated. For example, IL monitor 112 can evaluate the action by calling a reference scheduler with identical inputs and finding the reference action and compare the reference action to the actual action taken. In another example, RL monitor 114 can assess a reward received for the action to determine the quality of the action.

At 206, the action is determined to not generalize to the scheduler policy. In an embodiment, a gradient associated with the task (or batch of tasks) of the ML policy is determined. The gradient is used to compute a coherence. An insignificant change in the coherence value shows that the current ML policy handles the monitored application well. That is, the policy generalizes well to the monitored application. In contrast, a rise in coherence indicates new directions in the gradient, signifying the need to adopt the policy to address the changes in the workload. At 206, method 200 can alert or otherwise notify a user or administrator of the SoC that the action has not generalized to the existing scheduler policy.

Optionally, at 208, the scheduler policy is incrementally trained. Optionally, at 210, the incrementally-trained policy is implemented as the scheduler. Though not shown in FIG. 4, method 200 can optionally also fall back to a trusted policy instead of incrementally training the existing policy at 208-210.

Put differently, method 200 can at 202 record the input (task) and the output (action), at 204 check whether the action decisions make sense according to the training data, and at 206 flag when action(s) are do not generalize to the policy. A snapshot of tasks and actions that are recorded in the background (and allowed to run on the SoC) and subsequently evaluated allows for real-time operation.

As mentioned, method 200 is implemented as a background process. Method 200 moves on with the current scheduling decision to avoid interruption since an incorrect decision only leads to transient performance degradation but not catastrophic failure. Accordingly, monitoring operation is not on the critical path. However, monitoring operation overhead is still crucial since it determines how frequently the monitoring can be called as well as detection speed. In embodiments, monitoring and detection (e.g. 202-206) can be performed in the order of milliseconds, allowing frequent checks for the robustness of the ML policies. Given the types and composition of applications running on SoCs do not change in the order of seconds, embodiments enable runtime monitoring with negligible overhead, as will be explained further.

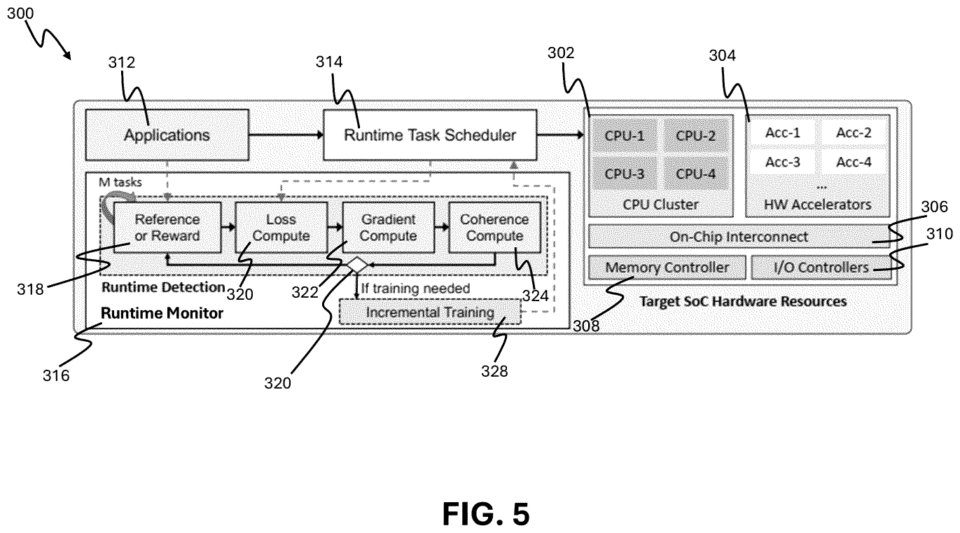

Referring to FIG. 5, a block diagram of an SoC scheduler monitoring system 300 is depicted, according to an embodiment. In one aspect, monitoring system 300 is configured to monitor scheduler decisions and application features used for decision making and optionally incrementally train the ML model implementing the scheduler decisions.

In an embodiment, system 300 is a SoC. System 300 generally comprises a plurality of hardware resources, including CPU cluster 302, hardware accelerators 304, on-chip interconnect 306, memory controller 308, and I/O controllers 310.

The plurality of hardware resources of the SoC can be utilized by one or more applications 312, a runtime task scheduler 314, and a runtime monitor 316. Applications 312, runtime task scheduler 314, and runtime monitor 316 can be respectively substantially similar to application(s) 108, runtime task scheduler 110, and IL monitor 112/RL monitor 114, and which are not redescribed here for brevity. However, additional functionality with respect to monitoring, such as by IL monitor 112, RL monitor 114, or runtime monitor 316 is described herein with respect to FIG. 5.

In an embodiment, runtime monitor 316 is configured to compute the coherence of a batch with M samples, such as tasks from application 312. Operations 318-328 can be implemented by runtime monitor 316. At 318, a reference (in the case of IL-based scheduling) or reward (in the case of RL-based scheduling) are evaluated. At 320, a loss is computed based at least in part on the reference or reward at 318. At 322, a gradient is computed based at least in part on the loss at 320. At 324, a coherence is computed based at least in part on the gradient at 322. From 324, if training is needed based on an evaluation of the coherence, incremental training for the scheduler policy is performed at 328, which can be implemented in runtime task scheduler 314. If training is not needed at 320, monitoring can proceed with another M tasks at 318.

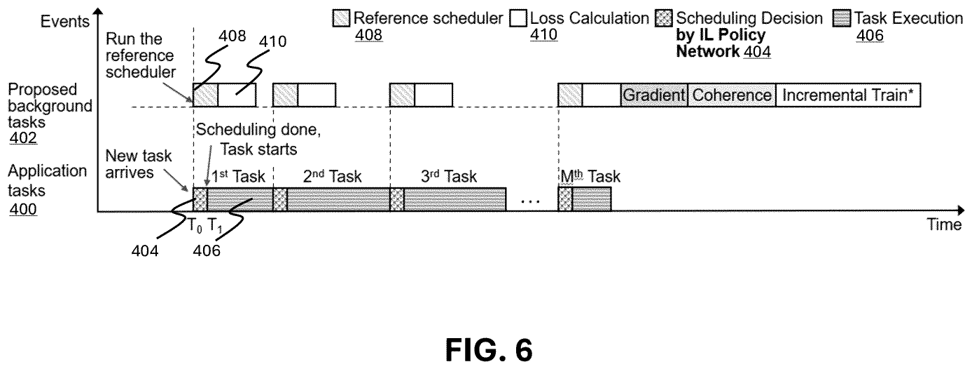

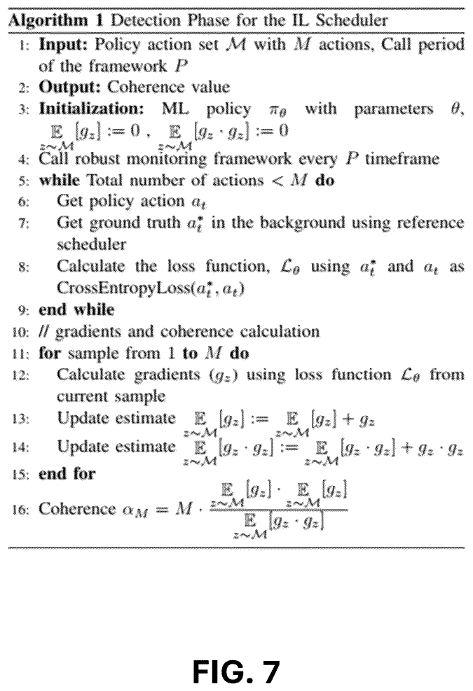

In an embodiment in which runtime monitor 316 monitors for IL-based scheduler, referring to FIG. 6, a block diagram of imitation learning-based scheduler monitoring operation is depicted, according to an embodiment. Referring also to FIG. 7, pseudocode of a detection algorithm for an imitation learning-based scheduler is depicted, according to an embodiment.

FIG. 6 illustrates tasks in series for clarity, but multiple parallel tasks can be scheduled and monitored concurrently. While monitoring IL schedulers, a trustworthy (but slower) scheduler runs in the background to determine the correct action (aₜ*). This reference and actual policy actions (aₜ) for a batch with M tasks are used for the loss, gradient, and coherence calculations (FIG. 7). The incremental training step is executed if it is determined that the IL model policy (π_{θ}) should be updated.

In FIG. 6, the row associated with application tasks 400 reflects the IL scheduler operation. The row associated with background tasks 402 reflects the trustworthy (reference) scheduler operation.

Once activated, runtime monitor 316 processes the actions (aₜ) taken by the policy (π_{θ}) for a sample size of M (FIG. 7, lines 4-5) A first task is evaluated for a scheduling decision by IL policy network at 404. The task execution (action) is subsequently executed at 406. The first task is also evaluated by the reference scheduler 408. A loss calculation 410 is conducted based on the reference scheduler operation. First tasks are labelled for ease of illustration, but 2^{nd} tasks, third tasks, to M tasks are likewise included, as depicted without labelling.

IL schedulers operate as supervised learning models, wherein an agent learns a policy (π_{θ}) from an expert's decision-making patterns to guide runtime scheduling decisions by generating actions (aₜ) (FIG. 7, line 6). Therefore, runtime detection uses the reference targets (aₜ*) obtained by invoking the expert scheduler and collects necessary performance metrics in the background to avoid execution time overhead (FIG. 7, line 7). In one example, a resource-intensive heuristic is employed, an earliest task first (ETF) scheduler that loops through all ready tasks and PEs to choose the task assignment that minimizes the expected execution time. An IL scheduler using ETF as the reference scheduler has an overhead that grows quadratically, ranging from 0.3 ms to 8 ms. In contrast, the IL scheduler overhead grows linearly and enables nanosecond-level decisions. Reference actions are used to compute the loss function, denoted as [symbol] _{θ} (FIG. 7, line 8), in conjunction with the IL policy actions. In an embodiment, cross-entropy loss is utilized for [symbol] _{θ}. Then, the loss function is used to calculate the gradients g_{z}. Subsequently, the expected value of the gradient vector,

$${𝔼}_{z ∼ ℳ} [ {g}_{z} ] ,$$

is calculated by adding the gradient vectors and

$${𝔼}_{z ∼ ℳ} [ {g}_{z} \cdot {g}_{z} ]$$

by adding the dot product of the gradient vectors of weights, respectively. This process can be executed efficiently, with expected values computed using running sums without storing the gradients, either incrementally or collectively, at each monitoring session's conclusion. Finally, the coherence is computed using Equation 2. The coherence of gradients is determined among all examples in the sample set [symbol] , thereby detecting the unforeseen task scheduling scenarios that differ significantly from those encountered during training. In an embodiment, the loss function is utilized for coherence instead of relying on accuracy because the accuracy metric misses differences when the policy generates the same actions with low confidence. Further, accuracy remains relatively stable when a few new application instances are added to the workload mix. The loss value, in contrast, is sensitive to such variations.

As illustrated in FIG. 6, a batch or snapshot of M tasks is evaluated, then gradient is calculated for the batch, then coherence is calculated for the batch, and optional incremental training is conducted based on the batch of M tasks. In one aspect, after the M tasks, no monitoring is conducted until the next batch is triggered. In another aspect, a new batch is immediately triggered for the M+1 task, to the M+M task, such that back-to-back batches are evaluated (e.g. in highly critical operation). In another aspect, a next batch is selected a given time after the M task (such as upon a new app launching, or randomly triggered). In another aspect, a trigger can include use of machine learning itself such that a trigger model can learn the most effective batches/triggers, and future batches/triggers can be based on the trigger model.

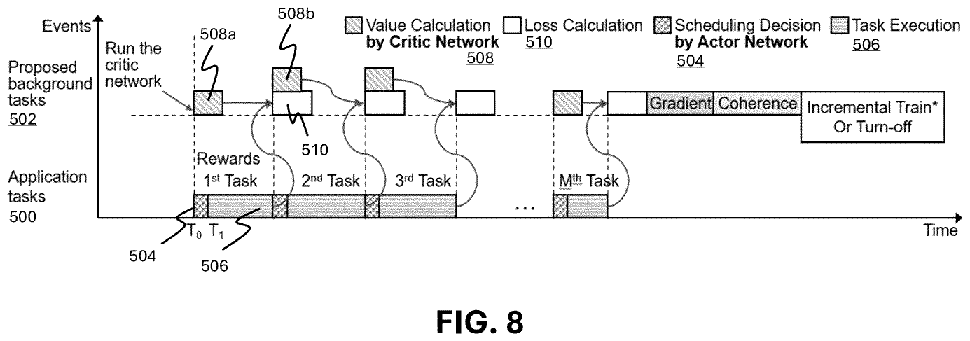

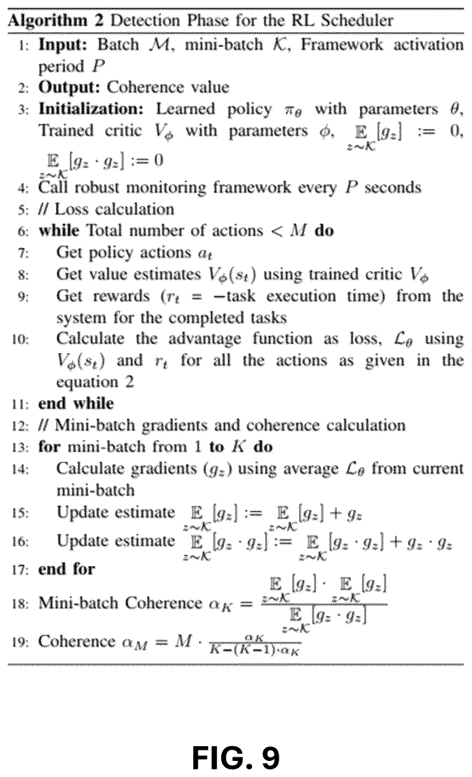

In an embodiment in which runtime monitor 316 monitors for RL-based scheduler, referring to FIG. 8, a block diagram of reinforcement learning-based scheduler monitoring operation is depicted, according to an embodiment. Referring also to FIG. 9, pseudocode of a detection algorithm for a reinforcement learning-based scheduler is depicted, according to an embodiment.

FIG. 8 illustrates tasks in series for clarity, but multiple parallel tasks can be scheduled and monitored concurrently. The row associated with application tasks 500 reflects the RL scheduler operation. The row associated with background tasks 502 reflects the critic network policy. Thus, in an embodiment, systems implementing an RL scheduler with RL scheduler monitoring implement two policies. A first policy is an actor network implementing device scheduling (e.g. on a decision tree due to the critical path). A second policy is a critic network that provides values and feedback used to train the actor network decision tree (e.g. on a neural network due to it not being on the critical path). Use of the critic network is in contrast to traditional systems in that once training is done, a critic network is generally not further used.

During monitoring, the actor policy (π_{θ}) makes scheduling decisions (action aₜ) at 504 for new tasks based on the SoC state (sₜ). The selected PEs process the tasks as normal at 506. As illustrated here, RL is an unsupervised learning method where both the actor network 500 and critic network 502 are trained during the offline training phase to maximize the reward defined as the negative execution time. Therefore, estimated state values (V_{φ}(sₜ)) from the trained critic network (e.g. 508a for 1^{st} Task) and rewards (rₜ) expressed as the negative of the task execution times are used to calculate the loss function [symbol] _{θ} at 510 required for the gradient calculation. As new tasks arrive, the trained critic network updates the state values in the background (e.g. 508b for 2^{nd} Task). Upon task completion, rewards in terms of execution time are acquired from the PEs. These rewards and the state values are used to calculate the advantage function (A(sₜ, aₜ)) for the state-action pair, following Equation 3:

$$A ( {s}_{t} , {a}_{t} ) = {r}_{t} + γ {V}_{ϕ} ( {s}_{t + 1} ) - {V}_{ϕ} ( {s}_{t} ) \qquad ( Equation 3 )$$

where γ represents the discount factor and V_{φ}(sₜ₊₁) is the state value after completion of the task.

The loss calculation during training also uses the ratio between the updated policy and the previous policy ρ(θ). Since the policy remains fixed during inference at runtime, the probability ratio ρ(θ) remains equal to one. Thus, policy loss [symbol] _{θ} is given by the advantage function in Equation 4 (used in FIG. 9 line 10).

$${ℒ}_{θ} = ρ ( θ ) \cdot A ( {s}_{t} , {a}_{t} ) ; ρ ( θ ) = \frac{{π}_{θ} ( {a}_{t} \vert {s}_{t} )}{{π}_{θ old} ( {a}_{t} \vert {s}_{t} )} = 1 \qquad ( Equation 4 )$$

Since this loss is not directly derived from the ground truth (e.g. because the loss is not derived from ground truth but from another critic network and reward), the resulting gradient and coherence become noisy. More particularly, if the loss of each decision directly were to be used (similar to IL), the gradients and coherence becomes noisy, and it can be difficult to detect new applications. In one aspect, embodiments therefore use mini-batches and the average loss from each mini-batch, as will be described, which reduces noise and further facilitates real-time execution.

Accordingly, to address noisy results, batch [symbol] is split (with M=| [symbol] | samples) into a set of [symbol] mini-batches (with K=| [symbol] | each of size M/K). Then, the average advantage within each mini-batch is used for gradient calculation (lines 13-17 in FIG. 9). The coherence for each mini-batch and the overall batch coherence are calculated using the theorem in lines 18-19 in FIG. 9. This theorem ensures statistical equivalence of the per-sample coherence described in Equation 1.

If the RL policy does not generalize to the current data point(s), it can be incrementally trained or turned off until the coherence reduces.

Accordingly, embodiments utilize a loss function and gradients to compute a coherence for detecting workload changes and can be applied to monitor the decisions of other ML-based schedulers and dynamic resource management (DRM) algorithms that allow runtime gradient calculation. For example, dynamic thermal and power management techniques determine the optimal voltage-frequency pairs for computing cores to meet thermal constraints while preserving performance. These algorithms encompass a variety of approaches, including IL and RL methods. Embodiments can therefore be implemented in such systems to prevent unexpected behavior due to a mismatch between training and runtime inputs. For example, in a hierarchical imitation learning framework featuring distinct policies for frequency, core selections, and execution time predictions, embodiments can effectively monitor these policies, utilizing the described policy and expert actions outlined in the study to compute loss and subsequent steps. Embodiments can ensure robust performance across various scenarios. In summary, embodiments offer monitoring support for any runtime machine learning-based framework that utilizes gradient-based optimizations, ensuring robustness and reliability across various dynamic runtime management applications.

Coherence can be utilized to determine significant changes in workload. More particularly, embodiments can detect the substantial changes in the workload to which the trained model does not generalize. For example, the detection's coherence (α_{M}) can be compared against a threshold (τ) learned during training. In one aspect, a simple classifier is employed, such as a support vector machine (SVM), to learn the threshold that maximizes the detection accuracy. Coherence values lower than the threshold (α_{M}<τ) indicate that scheduler decisions are trustworthy and no intervention is required. In contrast, larger coherence values (α_{M}>τ) require action since they indicate that the model is not generalizing well to samples.

In an embodiment, one of two responses can be implemented when a significant workload change deems the scheduler unreliable. In one aspect, the ML policy can fall back to a traditional algorithm (e.g., the reference scheduler) for actions. The ML scheduler decisions can be monitored during this time until the coherence value moves below the threshold. In this way, the SoC will be protected from unreliable ML decisions. In a second aspect, the scheduler can be incrementally trained to adapt to workload changes, which can conserve the advantages of using ML schedulers.

For example, monitoring an IL-based scheduler includes a reference scheduler whose decisions are used to compute the loss function, as shown in FIG. 6. Thus, the reference actions (aₜ*) for the samples received during monitoring (sₜ) are readily available, making incremental training a practical option. To this end, the state-action pairs (sₜ, aₜ*) are utilized to incrementally train the IL policy. In one aspect, the overhead of this training process takes approximately 2 ms per epoch for incremental training of the IL scheduler on an Nvidia Jetson Xavier NX board, a timeframe negligible compared to the domain-specific application lifecycle. The execution of the tasks continues with the previous policy to ensure continuity during this process. Subsequently, the IL scheduler starts using the new policy (\hat{π}).

In another example, in contrast to IL-based schedulers, RL training is unsupervised, learning from rewards (task execution time) provided by the environment (PEs in SoC) rather than a reference. Thus, the corresponding monitoring process does not involve a reference scheduler that gives correct actions. RL-based schedulers can be trained aₜ runtime using the rewards received aₜ the end of task executions. However, the RL scheduler can make poor decisions during this time, potentially impacting the runtime of tasks it executes. If this degradation in performance is acceptable, the policy can be incrementally updated during the operation. Otherwise, turning the policy off may be preferable while the coherence value is above the threshold. An RL policy can also be incrementally trained offline for updating of the scheduler if the workload changes are permanent.

### Experimental Evaluation

In an implementation, an SoC configuration is tailored to the requirements of domain-specific applications. For example, the SoC configuration comprises sixteen PEs, comprising eight general-purpose cores utilizing an ARM big.LITTLE architecture. These cores include four ARM A57 performance and four ARM A53 low-power cores. Additionally, the SoC incorporates eight fixed-function accelerators configured for handling intensive tasks: four accelerators dedicated to Fast Fourier Transform, two for Viterbi decoding, and two for matrix multiplication. This configuration is designed based on specific demands of the target domain applications and the computational intensities of the tasks in the following applications.

Runtime monitoring evaluation includes six real-world applications for telecommunication and radio frequency domains. These applications include WiFi transmitter, WiFi receiver, temporal mitigation, lag detection, single-carrier transmitter, and single-carrier receiver. The number of tasks for these applications varies from 7 to 34. Tasks are mixed into respective workloads spanning from lower to higher intensity levels, ensuring comprehensive coverage.

In evaluation of the monitoring using a simulation, an open-source discrete event-based simulator, DS3 is utilized. The DS3 simulator has been validated against two commercial SoCs, the Odroid-XU3 and the Zynq Ultrascale+ZCU102. The DS3 simulator allows target application simulations using different schedulers, providing a flexible environment for efficiently implementing new scheduling policies and the monitoring. Each simulation duration is around 2 seconds, resulting in a dynamic variation in the number of applications running, ranging from 4,000 to 40,000 instances, and an average task count ranging from 50,000 to 500,000.

In a first aspect with respect to an IL scheduler, a policy adopted for the IL scheduler comprises a neural network architecture consisting of three dense layers, each with 32 neurons. The neural network is trained using Python and TensorFlow libraries, achieving accuracies ranging between 96.1%-98.3% against the reference scheduler, ETF. The policy leverages a combination of system, application, and task-level data as features to determine the cluster assignment. Then, the task is assigned to the PE within the chosen cluster, which is either available or set to become available first.

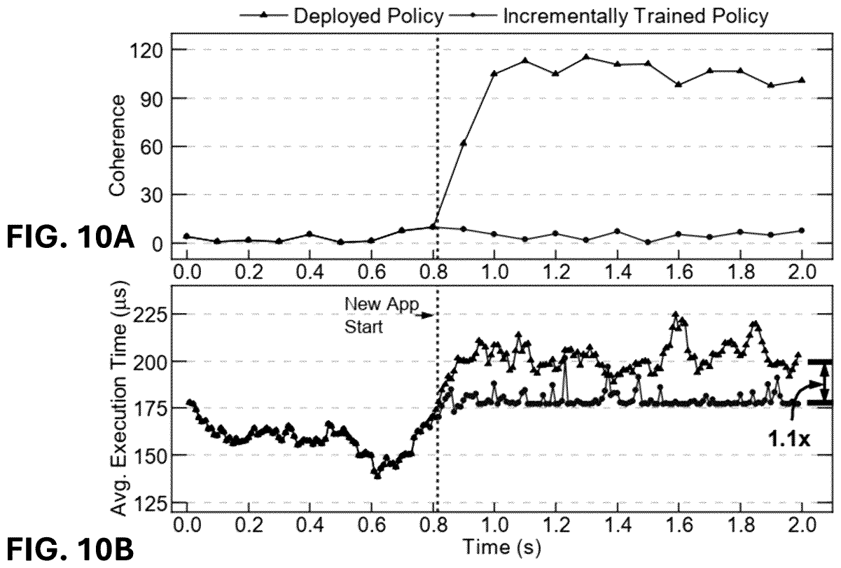

In a single application use case illustration, the simulation starts running a domain application represented in the training dataset. As the test samples from this application arrive at runtime, the coherence value remains low, as shown in FIG. 10A. In one example, the training and test samples are different except that they come from the same application. Since the execution time varies significantly over time, it cannot be used alone to identify significant workload changes. After running for 0.8 seconds, this application is replaced with a new one not represented in the training dataset. In the simulation, the monitor successfully captures this change, as shown in FIG. 10A. The coherence increases quickly, indicating the unalignment between the trained policy and the impact of new data samples. If action is not taken (e.g., incrementally train or turn off the scheduler), the coherence remains high, and execution time varies around 200 us. In contrast, an incrementally trained policy successfully adapts the policy to the new application, as illustrated by the low coherence. Furthermore, the execution time reduces on average by 10%, as shown in FIG. 10B, in the 1.1× difference in deployed policy vs. incrementally trained policy average execution time. Finally (though not shown), the incrementally trained policy still runs the first application optimally, i.e., the coherence remains low if the first application resumes running.

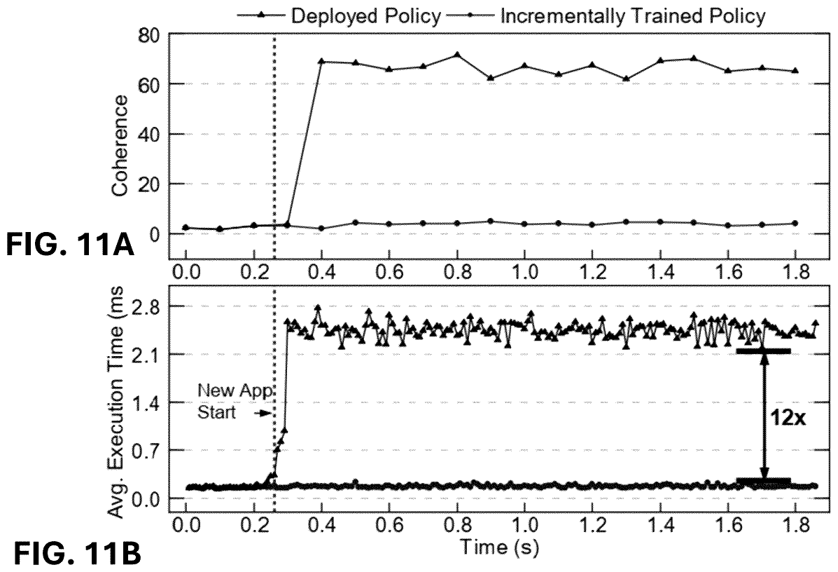

In a multiple application use case illustration, a mix of five applications represented in the training dataset is started. The coherence computed at runtime remains low, as expected, as shown in FIG. 11A. After running them for about 0.25 seconds (marked by a dotted line), these applications halt, and a previously unseen application starts running. The monitor successfully tracks the increased coherence after this change. As in the previous example, an elevated coherence indicates that new data samples require updating the policy parameters. If the policy is not updated, coherence remains high, and the execution time rises to about 2.5 ms, as shown in FIG. 11B. In contrast, the incrementally trained policy rapidly reduces coherence to its original value. Moreover, the incrementally trained policy achieves a performance boost (12× lower execution time) compared to no training.

To further capture accuracy and performance in IL monitoring, other use case scenarios were simulated. A randomly selected subset of application mixes were started and then randomly changed. Single application examples start running one of the six domain applications randomly and switch to another one after a random duration. These simulations were repeated at different intensities and obtained 1221 batches. 663 out of these 1221 points indicate inputs the ML scheduler does not generalize. The multi-application experiments start running five out of six applications concurrently (leaving one out). Then, the missing application replaces the original one. These experiments are also repeated to obtain 13767 batches. 8585 of these 13767 batches correspond to input the ML scheduler does not generalize. Overall, the combined data set comprises 14988 batches, of which 9248 batches indicate a significant input change.

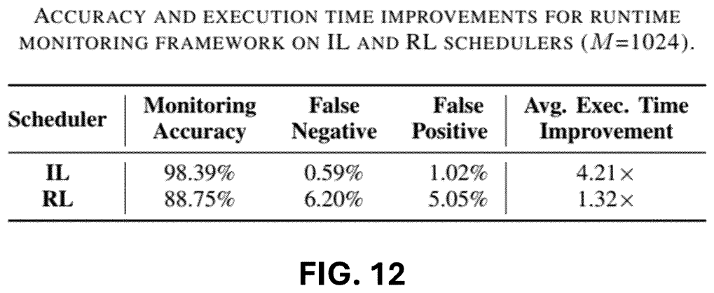

The monitor identifies whether the IL scheduler generalizes to new data points correctly 98.39% of the time, as summarized in FIG. 12 (IL row). False positives in FIG. 12 occur when activity is detected despite there being no new application. False negatives, on the other hand, occur when a non-generalized application appears but is not detected. The IL scheduler's false positive rate is only 1.02%, which means it incorrectly flags a change, although the scheduler generalizes well to the input. More importantly, the scheduler almost never misses a significant input change (0.59%). Finally, the monitor simulation enables 4.21× lower execution time on average when incremental training is performed. Accordingly, the IL monitor can effectively detect when the IL scheduler makes unreliable decisions and adapt the scheduler to achieve substantial benefits.

In a second aspect with respect to an RL scheduler, the RL scheduler comprises an actor policy for decision-making and a critic network for evaluation. The actor policy is responsible for scheduling decisions and is situated on the critical path of the main process. Therefore, it is implemented using a DDT, enabling scheduling in approximately 0.18 μs on an Nvidia Jetson Xavier NX board. Once a scheduling decision is made, the main process executes tasks on PEs while the monitor concurrently monitors these decisions in the background. Actor-critic policies utilize features encompassing task, application, and SoC-level information (similar to those described with respect to the IL scheduler above). These policies are trained using PyTorch with an OpenAI Gym environment.

All six domain applications were utilized in a leave-one-out simulation for a comprehensive performance evaluation. The RL scheduler generalizes well to five of these applications, even when they are excluded from training. However, the RL scheduler performs poorly when running the last application (temporal mitigation), indicating that the RL scheduler does not generalize to this application and does not make robust decisions. The monitor confirms this observation, as coherence values remain consistently low even with the arrival of new applications, except for “temporal mitigation,” where coherence increases when the RL policy schedules it. Each batch (M) used in monitoring comprises 1024 samples, each divided into eight mini-batches (K) with 128 samples.

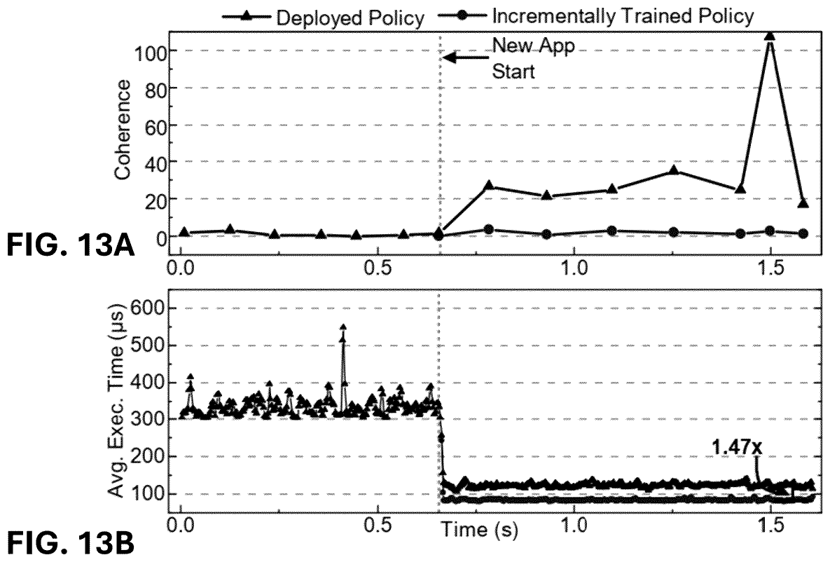

In a single application use case illustration, a single application is represented in the training dataset. The coherence computed by the proposed framework is low during this time, as illustrated in FIG. 13A. Subsequently, the application is replaced with a new application, to which the RL scheduler does not generalize. The coherence value sharply increases from approximately zero to over 20 following this change, as shown in FIG. 13A. Correspondingly, there is a sudden decrease in execution time, as shown in FIG. 13B. This decrease occurs because the new application has inherently shorter execution times. However, note that a shorter execution time does not necessarily indicate that the RL scheduler has successfully generalized to the new application. Rather, the policy undergoes incremental offline training to adjust to a new application. The policy retains its performance for the initial application while being optimized for the new application. With the incrementally trained policy, the average execution time decreases by 1.47×.

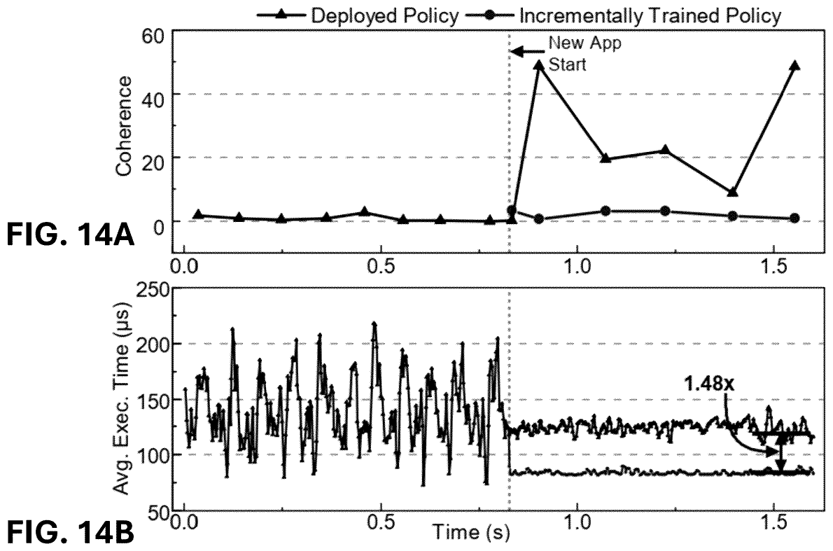

In a multiple application use case illustration, a mix of five out of six domain applications is started. Coherence during this time is low since these applications are represented during training, as shown in FIG. 14A. Then, a new application not represented in the training replaces the original mix (new app start). The monitor successfully captures this change, as indicated by the abrupt increase in coherence after the dotted line. The execution time varies widely during the initial period, but it has a similar average value with lower variation after the new application is launched. This behavior shows that execution time is not a reliable indicator of the scheduler's generalizability. Finally, FIG. 14B illustrates the scheduler incrementally training to adapts to the new application, enabling 1.48× lower execution time.

To further capture accuracy and performance in RL monitoring, other use case scenarios were simulated, including for varying application loads. For single-application examples, the RL monitor was evaluated across a total of 3685 batches (each comprising M=1024 tasks). The RL scheduler fails to generalize to 666 of these batches coming from the new application. In the case of multiple applications, the RL monitor was evaluated for over 1168 batches, with 161 batches indicating a lack of generalization. Overall, the monitor was evaluated for 4853 batches. As discussed previously, the RL scheduler demonstrates inherent generalization to five applications, resulting in fewer instances of non-generalized cases than the IL scheduler.

Referring again to FIG. 12, accuracy and performance benefits of the RL scheduler (RL row) are depicted. Embodiments can determine whether the scheduler generalizes to the new inputs or not with 88.75% accuracy. Closing inspection reveals a 6.2% false negative rate, i.e., the frequency of failing to detect a new application. Similarly, the monitor incorrectly flags the lack of generalization to a new application (false positive) for 5.05% of the batches. Finally, when embodiments identify a new application, incremental training provides, on average, a 1.32× lower execution time.

As described herein, embodiments are not on the critical path since embodiments operate in the background. An overhead analysis is still helpful since it helps determine how frequently the monitoring can be triggered. As further described herein, in domain-specific SoC applications continuously process streaming inputs for extended durations after launch. Therefore, embodiments of monitors do not need to run continuously. Rather, monitoring (or its computational analysis) can be triggered when a new application launches or periodically while sleeping most of the time. The following overhead analysis summarizes the execution overhead as a function of the batch size (M). These values determine the shortest possible monitoring period.

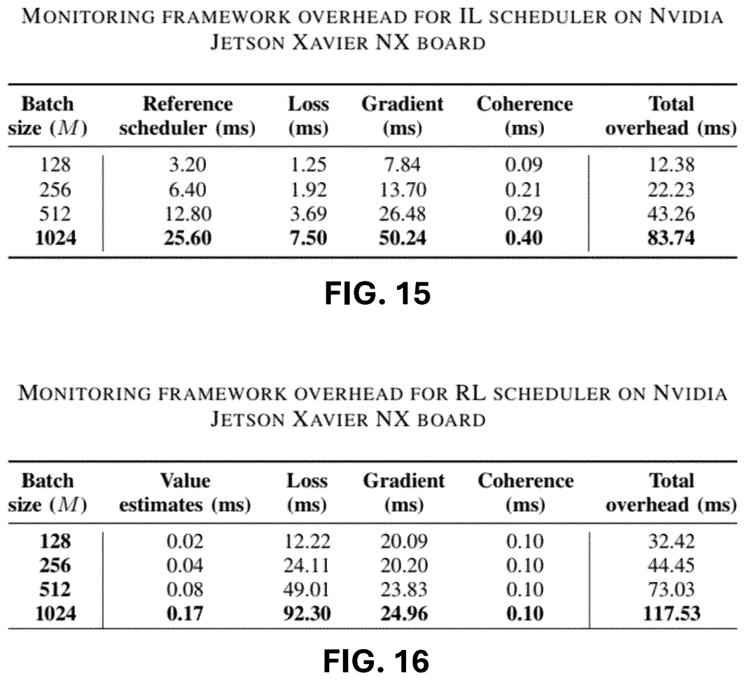

FIG. 15 summarizes the overhead for monitoring an IL scheduler when running on an Nvidia Jetson Xavier NX board. The most time-consuming step is the gradient calculation, varying from 7.84 ms to 50.24 ms as the batch size grows from 128 to 1024. The second largest contributor is running the reference scheduler, which takes 3.2 ms to 25.6 ms. In embodiments, different components of the monitoring framework can be pipelined. For example, the reference scheduler can start running for the next task after the loss calculation begins. Hence, the total execution time in FIG. 15 is a loose upper bound. Regardless, measurements show that the entire monitoring process takes 83.74 ms, even for the largest batch size used in simulation. A smaller batch size can be employed to speed up the monitoring process at the expense of accuracy. The last row (bolded) highlights the setting for the aforementioned simulations, while evaluations shown for all batch sizes are listed in the other rows of FIG. 15. Accordingly, the monitoring can be repeated in the background with this period if needed.

FIG. 16 summarizes the monitoring and detection overhead for RL schedulers as a function of the batch size (M). The loss and gradient calculations dominate the total execution time for RL schedulers. The loss takes longer than those for the IL scheduler since loss for IL is the mean squared error, but RL requires solving Equation 4. As in the IL scheduler, the value estimate, loss, and gradient calculations can be pipelined. In the worst case, when all steps are performed sequentially, the total execution time varies from 32.42 ms to 117.53 ms as the batch size grows from 128 to 1024. The last row (bolded) highlights the setting for the aforementioned simulations. Like in the IL case, all batch sizes in the table lead to effective monitoring. Hence, embodiments can run as a real-time background task to monitor RL schedulers. Further, because coherence can be calculated using a running sum

$${𝔼}_{z ∼ ℳ} [ {g}_{z} ] and {𝔼}_{z ∼ ℳ} [ {g}_{z} \cdot {g}_{z} ]$$

vectors, this ensures that the memory requirement does not scale with the batch size M, meaning the memory requirement remains constant, or O(1). More particularly, for the entire background process, only 2N values need to be stored (N for

$${𝔼}_{z ∼ ℳ} [ {g}_{z} ]$$

and another N for

$${𝔼}_{z ∼ ℳ} [ {g}_{z} \cdot {g}_{z} ] ,$$

where N is the total number of trainable parameters of the ML scheduler.

With reference to memory overhead, in one example, an IL model is trained with a neural network. The IL model uses a total of 29 input features and the scheduler select from 5 clusters. For runtime efficiency, a shallow neural network that has only 3 linear layers of size 32 is utilized. A linear layer with M inputs and K outputs have a total of (M×K+K (bias)) learnable parameters. Total trainable parameters are:

$$Layer 1 : 29 \times 32 + 32 = 960$$

$$Layer 2 : 32 \times 32 + 32 = 1056$$

$$Layer 3 : 32 \times 5 + 5 = 165$$

N=2181 parameters.

Thus, the background process requires a total 2N=4362 values to store at runtime. Assuming each value is 4 bytes, this results in ˜17 KB memory overhead.

With reference to memory overhead, in another example, an RL model is trained with a Differential Decision Tree (DDT), which comprise decision nodes and leaf nodes. In DDT, each decision node in the tree can be expressed as a sigmoid function as Equation 5.

$${p}_{η} = \frac{1}{1 + {e}^{- ( {a}_{η} ( {w}_{η}^{T} x - {ϕ}_{η} ) )}} \qquad ( Equation 5 )$$

where x is the input feature (x∈ [symbol] ^{F}, F is total features), w_{η} and φ_{η} are learnable weights and bias of the node η and α_{η} is the steepness parameter, which is also a learnable parameter. To classify from 5 clusters, each leaf node has 5 learnable parameters.

Using a tree of depth 3, a total (1+2+4=7) decision nodes and 8 leaf nodes resulted. A total (F=16) features were used, so total trainable parameters:

$$Decision nodes : 7 \times ( 16 ( F ) + 1 ( {ϕ}_{η} ) ) + 1 ( {α}_{η} ) = 120$$

$$Leaf nodes : 8 \times 5 = 40$$

N=160 learnable parameters

Thus, the background process requires a total 2N=320 values to store at runtime. Assuming each value is 4 bytes, this results in 1.25 KB memory overhead.

In other examples, using onboard sensors, power utilization and temperature changes on the Jetson Xavier NX were also monitored. It was observed that the Jetson Xavier NX consistently consumes less than 1 W of power. So, embodiments require a maximum of 83.74 mJ for the IL case and 117.53 mJ for the RL case. Due to this very low energy consumption, only a 3-4° C. increase in temperature was observed. This analysis shows that embodiments have a negligible impact compared to the application running on the target SoCs.

1. A method of runtime monitoring a machine learning-based (ML) scheduler for a system-on-chip (SoC), the method comprising:
determining a scheduling action by the ML-based scheduler for an SoC task, the scheduling action based on a policy trained from training data;
permitting the scheduling action to be processed by at least one processing element of the SoC;
evaluating a quality of the scheduling action; and
determining the scheduling action does not generalize to the policy based on the quality of the scheduling action.

2. The method of claim 1, wherein the method executes in SoC background not on a critical path of SoC operation.

3. The method of claim 1, further comprising:
incrementally retraining the policy to generate an updated policy; and
implementing the updated policy for the ML-based scheduler.

4. The method of claim 1, wherein determining the scheduling action does not generalize to the policy based on the quality of the scheduling action further comprises:
calculating a gradient of the policy for a batch of SoC tasks and associated scheduling actions, wherein the policy is grained with gradient descent;
calculating a coherence based on the gradient; and
comparing the coherence against a coherence threshold, wherein a sustained high coherence reflects the scheduling action being not generalized to the policy.

5. The method of claim 4, further comprising:
triggering incremental retraining of the policy based on the coherence being above the coherence threshold.

6. The method of claim 1, wherein the ML-based scheduler is implemented by imitation learning, wherein evaluating the quality of the scheduling action further comprises:
implementing a reference scheduler trained by a neural network using at least the training data;
obtaining a ground truth action from the reference scheduler for the SoC task; and
calculating a loss based on the ground truth action and the scheduling action.

7. The method of claim 6, further comprising:
incrementally retraining the policy to generate an updated policy using the ground truth action and an SoC state pair; and
implementing the updated policy for the ML-based scheduler.

8. The method of claim 1, wherein the ML-based scheduler is implemented by reinforcement learning, wherein evaluating the quality of the scheduling action further comprises:
implementing a critic network initially trained based on the training data;
obtaining a critic value for the SoC task from the critic network; and
calculating a loss function using the critic value and a reward associated with the scheduling action for the SoC task from the policy implemented by reinforcement learning.

9. The method of claim 8, further comprising:
incrementally retraining the policy to generate an updated policy using the SoC task and the reward associated with the scheduling action for the SoC task; and
implementing the updated policy for the ML-based scheduler.

10. The method of claim 1, wherein the scheduling action is evaluated as part of a batch of SoC tasks and associated scheduling actions.

11. A system for runtime monitoring for a system-on-chip (SoC), the system comprising:
at least one processing element (PE) configured to execute SoC application tasks;
a memory operably coupled to the at least one PE;
a runtime task scheduler implementing a machine learning (ML)-based policy for SoC application task scheduling; and
a runtime monitor configured to:
determine a scheduling action by the ML-based scheduler for an SoC application task,
permit the scheduling action to be processed by the at least one PE,
evaluate a quality of the scheduling action, and
determine the scheduling action does not generalize to the policy based on the quality of the scheduling action.

12. The system of claim 11, wherein the runtime monitor executes in SoC background not on a critical path of SoC operation.

13. The system of claim 11, wherein the runtime monitor is further configured to:
incrementally retrain the policy to generate an updated policy; and
implement the updated policy on the ML-based scheduler.

14. The system of claim 11, wherein the runtime monitor is further configured to determine the scheduling action does not generalize to the policy based on the quality of the scheduling action including:
calculating a gradient of the policy for a batch of SoC application tasks and associated scheduling actions, wherein the policy is grained with gradient descent;
calculating a coherence based on the gradient; and
comparing the coherence against a coherence threshold, wherein a sustained high coherence reflects the scheduling action being not generalized to the policy.

15. The system of claim 14, wherein the runtime monitor is further configured to trigger incremental retraining of the policy based on the coherence being above the coherence threshold.

16. The system of claim 11, wherein the ML-based scheduler is implemented by imitation learning (IL) and the runtime task scheduler is an IL-based monitor, wherein evaluating the quality of the scheduling action further comprises:
implementing a reference scheduler trained by a neural network using at least the training data;
obtaining a ground truth action from the reference scheduler for the SoC application task; and
calculating a loss based on the ground truth action and the scheduling action.

17. The system of claim 16, wherein the IL-based monitor is further configured to:
incrementally retrain the policy to generate an updated policy using the ground truth action and an SoC state pair; and
implement the updated policy for the ML-based scheduler.

18. The system of claim 11, wherein the ML-based scheduler is implemented by reinforcement learning (RL) and the runtime task scheduler is an RL-based monitor, wherein evaluating the quality of the scheduling action further comprises:
implementing a critic network initially trained based on the training data;
obtaining a critic value for the SoC task from the critic network; and
calculating a loss function using the critic value and a reward associated with the scheduling action for the SoC task from the policy implemented by reinforcement learning.

19. The system of claim 18, wherein the RL-based monitor is further configured to:
incrementally retrain the policy to generate an updated policy using the SoC task and the reward associated with the scheduling action for the SoC task; and
implement the updated policy for the ML-based scheduler.

20. A computer readable media comprising non-transitory computer executable instructions which, when executed by at least one processing element on a system-on-chip (SoC), perform at least:
determining a scheduling action by the ML-based scheduler for an SoC task, the scheduling action based on a policy trained from training data;
permitting the scheduling action to be processed by at least one processing element of the SoC;
evaluating a quality of the scheduling action; and
determining the scheduling action does not generalize to the policy based on the quality of the scheduling action.
